(19) United States
(12) Patent Application Publication
(10) Pub. No.: US 2024/0427987 A1
(43) Pub. Date: Dec. 26, 2024

(54) AR DEVICE AND METHOD FOR CONTROLLING AR DEVICE

(71) Applicant: LG ELECTRONICS INC., Seoul (KR)

(72) Inventor: Sungkwon JANG, Seoul (KR)

(73) Assignee: LG ELECTRONICS INC., Seoul (KR)

(21) Appl. No.: 18/708,173

(22) PCT Filed: Nov. 8, 2021
(86) PCT No.: PCT/KR2021/016104

§ 371 Date: May 7, 2024

(51) Int. Cl. G06F 40/274; G06F 3/01; G06T 13/40; G06T 19/00

(52) U.S. Cl. CPC G06F 40/274; G06F 3/013; G06T 13/40; G06T 19/006

(57) ABSTRACT

The present disclosure provides an AR device comprising: a voice pickup sensor which identifies an input of a character; an eye tracking unit which senses an eye movement through a camera; a lip shape tracking unit which analogizes the character: and an autocompletion unit which completes a word on the basis of the analogized character.

### TECHNICAL FIELD

The present disclosure relates to an augmented reality (AR) device and a method for controlling the same.

### BACKGROUND ART

Metaverse is a compound word of “meta” meaning virtual and “universe” meaning the real world. The metaverse refers to a three-dimensional (3D) virtual world where social/economic/cultural activities similar to the real world take place.

In the metaverse, users can make their own avatars, communicate with other users, and engage in in economic activities, so that such users' daily life can be realized in the virtual world of the metaverse.

Unlike the existing game services in which the ownership of in-game items lies with the content manufacturing company according to contractual terms and conditions, blockchain-based metaverse can enable in-game items for the virtual world to be implemented as non-fungible tokens (NFTs), cryptocurrency, etc. In other words, the blockchain-based metaverse can allow users of content to have actual ownership of the content.

In recent times, game companies are actively working to build a blockchain-based metaverse. In fact, Roblox, an American metaverse game company recently listed on the New York Stock Exchange, has attracted many people's attention when it decided to introduce virtual currency. Currently, Roblox has secured more than 400 million users around the world.

Recently, as the metaverse has been introduced to mobile devices, the metaverse provides not only interaction between users and avatars in virtual spaces based on displays on smartphones and tablets, but also mutual communication between metaverse users through users' avatars in virtual spaces.

For interaction between such avatars, users need to quickly and accurately input desired letters (or characters) to their devices.

Accordingly, there is a growing need to implement devices accessible to the metaverse as products that not only implement high-quality lightweight optical systems but also enable interactions suitable for office environments or social networking services (SNS).

### DISCLOSURE

### Technical Problem

The present disclosure aims to solve the above-described problems and other problems.

An AR device and a method for controlling the same according to the embodiments of the present disclosure can provide an interface for enabling the user to input desired letters more correctly and precisely to the AR device.

### Technical Solutions

In accordance with one aspect of the present disclosure, an augmented reality (AR) device may include: a voice pickup sensor configured to confirm an input of at least one letter; an eye tracking unit configured to detect movement of user's eyes through a camera; a lip shape tracking unit configured to infer the letter; and an automatic completion unit configured to complete a word based on the inferred letter.

The voice pickup sensor may confirm the letter input based on bone conduction caused by movement of a user's skull-jaw joint.

The lip shape tracking unit may infer the letter through an infrared (IR) camera and an infrared (IR) illuminator.

The lip shape tracking unit may infer the letter based on a time taken for the eye tracking unit to sense the movement of the user's eyes.

The IR camera and the IR illuminator may be arranged to photograph lips of the user at a preset angle.

The AR device may further include: a display unit, wherein the display unit outputs an image of a letter input device and further outputs a pointer on the letter input device based on the detected eye movement.

The display unit may output a completed word obtained through the automatic completion unit.

The AR device may further include an input unit.

The voice pickup sensor may start confirmation of letter input based on a control signal received through the input unit.

The AR device may further include a memory unit.

The lip shape tracking unit may infer the letter based on a database included in the memory unit.

The lip shape tracking unit may infer the letter using artificial intelligence (AI).

In accordance with another aspect of the present disclosure, a method for controlling an augmented reality (AR) device may include: confirming an input of at least one letter based on bone conduction caused by movement of a user's skull-jaw joint; detecting movement of user's eyes through a camera; inferring the letter through an infrared (IR) camera and an infrared (IR) illuminator; and completing a word based on the inferred letter.

### Advantageous Effects

The effects of the AR device and the method for controlling the same according to the embodiments of the present disclosure will be described as follows.

According to at least one of the embodiments of the present disclosure, there is an advantage that letters (or text) can be precisely input to the AR device in an environment requiring silence.

According to at least one of the embodiments of the present disclosure, the AR device and the method for controlling the same according to the present disclosure may have advantages in that an input time to be consumed for the user to input letters or sentences (text messages) can be shortened due to error correction and automatic completion functions.

Additional ranges of applicability of the examples described in the present application will become apparent from the following detailed description. It should be understood, however, that the detailed description and preferred examples of this application are given by way of illustration only, since various changes and modifications within the spirit and scope of the described examples will be apparent to those skilled in the art.

### DESCRIPTION OF DRAWINGS

FIG. 1 is a block diagram illustrating an augmented reality (AR) device implemented as an HMD according to an embodiment of the present disclosure.

FIG. 2 is a diagram illustrating an AR device implemented as AR glasses according to an embodiment of the present disclosure.

FIGS. 3A and 3B are conceptual diagrams illustrating an AR device according to an embodiment of the present disclosure.

FIGS. 4A and 4B are diagrams illustrating problems of a text input method of a conventional AR device.

FIG. 5 is a diagram illustrating constituent modules of the AR device according to an embodiment of the present disclosure.

FIG. 6 is a diagram illustrating a voice pickup sensor according to an embodiment of the present disclosure.

FIG. 7 is a diagram illustrating an example of sensors arranged in the AR device according to an embodiment of the present disclosure.

FIG. 8 is a diagram illustrating a tracking result of a lip tracking unit according to an embodiment of the present disclosure.

FIG. 9 is a diagram illustrating the operations of an eye tracking unit according to an embodiment of the present disclosure.

FIG. 10 is a diagram illustrating the accuracy of the eye tracking unit according to an embodiment of the present disclosure.

FIG. 11 is a diagram illustrating a text input environment of the AR device according to an embodiment of the present disclosure.

FIGS. 12A and 12B are diagrams showing text input results of the AR device according to an embodiment of the present disclosure.

FIG. 13 is a diagram illustrating a table predicting a recognition rate for text input in the AR device according to an embodiment of the present disclosure.

FIG. 14 is a flowchart illustrating a method of controlling the AR device according to an embodiment of the present disclosure.

### BEST MODE

Description will now be given in detail according to exemplary embodiments disclosed herein, with reference to the accompanying drawings. For the sake of brief description with reference to the drawings, the same or equivalent components may be provided with the same reference numbers, and description thereof will not be repeated. In general, a suffix such as “module” and “unit” may be used to refer to elements or components. Use of such a suffix herein is merely intended to facilitate description of the specification, and the suffix itself is not intended to give any special meaning or function. In the present disclosure, that which is well-known to one of ordinary skill in the relevant art has generally been omitted for the sake of brevity. The accompanying drawings are used to help easily understand various technical features and it should be understood that the embodiments presented herein are not limited by the accompanying drawings. As such, the present disclosure should be construed to extend to any alterations, equivalents and substitutes in addition to those which are particularly set out in the accompanying drawings.

It will be understood that although the terms first, second, etc. may be used herein to describe various elements, these elements should not be limited by these terms. These terms are generally only used to distinguish one element from another.

It will be understood that when an element is referred to as being “connected with” another element, the element can be connected with the other element or intervening elements may also be present. In contrast, when an element is referred to as being “directly connected with” another element, there are no intervening elements present.

A singular representation may include a plural representation unless it represents a definitely different meaning from the context.

The terms such as “include” or “has” should be understood that they are intended to indicate an existence of several components, functions or steps, disclosed in the specification, and it is also understood that greater or fewer components, functions, or steps may likewise be utilized.

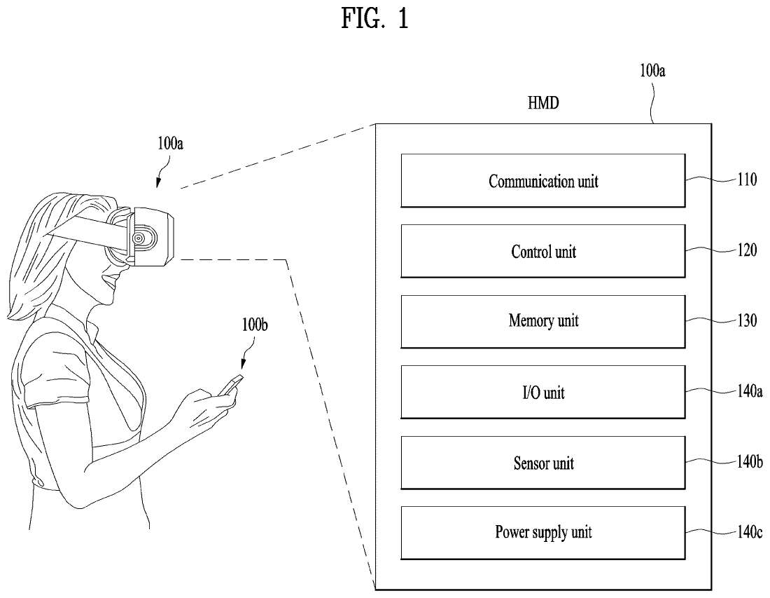

FIG. 1 is a block diagram illustrating an AR device 100a implemented as an HMD according to an embodiment of the present disclosure.

Referring to FIG. 1, the HMD-type AR device 100a may include a communication unit 110, a control unit 120, a memory unit 130, an input/output (I/O) unit 140a, a sensor unit 140b, and a power-supply unit 140c, etc.

Here, the communication unit 110 may transmit and receive data to and from external devices such as other AR devices or AR servers through wired or wireless communication technology. For example, the communication unit 110 may transmit and receive sensor information, a user input, learning models, and control signals to and from external devices. In this case, communication technology for use in the communication unit 110 may include Global System for Mobile communication (GSM), Code Division Multi Access (CDMA), Long Term Evolution (LTE), Wireless LAN (WLAN), Wi-Fi (Wireless-Fidelity), Bluetooth™, Radio Frequency Identification (RFID), Infrared Data Association (IrDA), ZigBee, Near Field Communication (NFC), etc. In particular, the communication unit 110 in the AR device 10a may perform wired and wireless communication with a mobile terminal 100b.

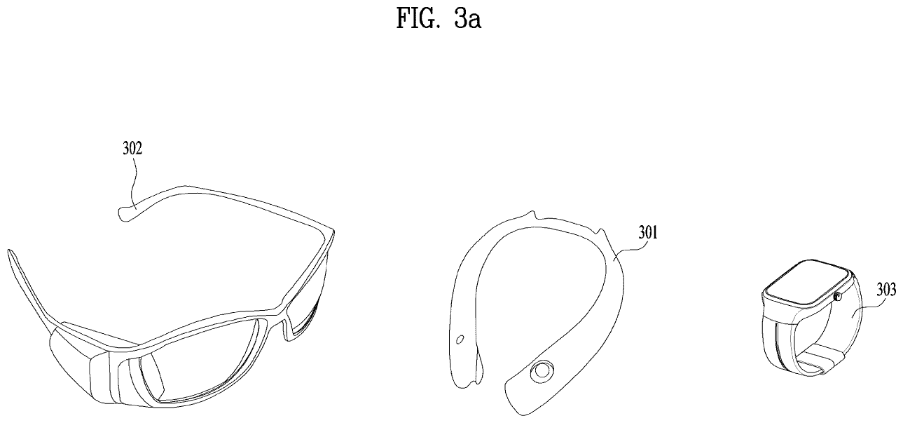

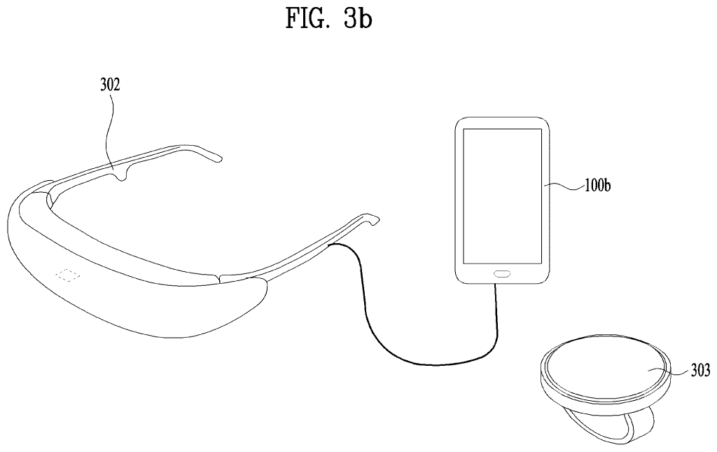

In addition to the operation related to the application programs, the control unit 120 may control overall operation of the AR device 100a. The control unit 120 may process signals, data, and information that are input or output through the above-described constituent components of the AR device 100a, or may drive the application programs stored in the memory unit 130, so that the control unit 180 can provide the user with appropriate information or functions or can process the appropriate information or functions. In addition, the control unit 120 of the AR device 100a is a module that performs basic control functions, and when battery consumption is large or the amount of information to be processed is large, the control unit 120 may perform information processing through the connected external mobile terminal 100b. This will be described in detail below with reference to FIGS. 3A and 3B.

The memory unit 130 may store data needed to support various functions of the AR device 100a. The memory unit 130 may store a plurality of application programs (or applications) executed in the AR device 100a, and data or instructions required to operate the mobile terminal 100. At least some of the application programs may be downloaded from an external server through wireless communication. For basic functions of the AR device 100a, at least some of the application programs may be pre-installed in the AR device 100a at a stage of manufacturing the product. Meanwhile, the application programs may be stored in the memory unit 130, and may be installed in the AR device 100a, so that the application programs can enable the mobile terminal to perform necessary operations (or functions) by the control unit 120.

The I/O unit 140a may include both an input unit and an output unit by combining the input unit and the output unit. The input unit may include a camera (or an image input unit) for receiving image signals, a microphone (or an audio input unit) for receiving audio signals, and a user input unit (e.g., a touch key, a mechanical key, etc.) for receiving information from the user. Voice data or image data collected by the input unit may be analyzed so that the analyzed result can be processed as a control command of the user as necessary.

The camera may process image frames such as still or moving images obtained by an image sensor in a photographing (or capture) mode or a video call mode. The processed image frames may be displayed on the display unit, and may be stored in the memory unit 130. Meanwhile, a plurality of cameras may be arranged to form a matrix structure, and a plurality of pieces of image information having various angles or focuses may be input to the AR device 100a through the cameras forming the matrix structure. Additionally, a plurality of cameras may be arranged in a stereoscopic structure to acquire left and right images for implementing a three-dimensional (3D) image.

The microphone may process an external audio signal into electrical voice data. The processed voice data may be utilized in various ways according to functions (or application program being executed) being performed in the AR device 100a. Various noise cancellation algorithms for cancelling (or removing) noise generated in the process of receiving an external audio signal can be implemented in the microphone.

The user input unit may serve to receive information from the user. When information is input through the user input unit, the control unit 120 may operate the AR device 100a to correspond to the input information. The user input unit may serve to receive information from the user. When information is input through the user input unit, the control unit 120 can operate the AR device 100a to correspond to the input information. The user input unit may include a mechanical input means (for example, a key, a button located on a front and/or rear surface or a side surface of the AR device 100a, a dome switch, a jog wheel, a jog switch, and the like), and a touch input means. For example, the touch input means may include a virtual key, a soft key, or a visual key which is displayed on the touchscreen through software processing, or may be implemented as a touch key disposed on a part other than the touchscreen. Meanwhile, the virtual key or the visual key can be displayed on the touchscreen while being formed in various shapes. For example, the virtual key or the visual key may be composed of, for example, graphics, text, icons, or a combination thereof.

The output unit may generate output signals related to visual, auditory, tactile sensation, or the like. The output unit may include at least one of a display unit, an audio output unit, a haptic module, and an optical (or light) output unit. The display unit may construct a mutual layer structure along with a touch sensor, or may be formed integrally with the touch sensor, such that the display unit can be implemented as a touchscreen. The touchscreen may serve as a user input unit that provides an input interface to be used between the AR device 100a and the user, and at the same time may provide an output interface to be used between the AR device 100a and the user.

The audio output module may output audio data received from the wireless communication unit or stored in the memory unit 130 in a call signal reception mode, a call mode, a recording mode, a voice recognition mode, a broadcast reception mode, and the like. The audio output module may also output sound signals related to functions (e.g., call signal reception sound, message reception sound, etc.) performed by the AR device 100a. The audio output module may include a receiver, a speaker, a buzzer, and the like.

The haptic module may be configured to generate various tactile effects that a user feels, perceives, or otherwise experiences. A typical example of a tactile effect generated by the haptic module is vibration. The strength, pattern and the like of the vibration generated by the haptic module may be controlled by user selection or setting by the control unit 120. For example, the haptic module may output different vibrations in a combining manner or a sequential manner.

The optical output module may output a signal for indicating an event generation using light of a light source of the AR device 100a. Examples of events generated in the AR device 100a include message reception, call signal reception, a missed call, an alarm, a schedule notice, email reception, information reception through an application, and the like.

The sensor unit 140b may include one or more sensors configured to sense internal information of the AR device 100a, peripheral environmental information of the AR device 100a, user information, and the like. For example, the sensor unit 140b may include at least one of a proximity sensor, an illumination sensor, a touch sensor, an acceleration sensor, a magnetic sensor, a gravity sensor (G-sensor), a gyroscope sensor, a motion sensor, an RGB sensor, an infrared (IR) sensor, a finger scan sensor, a ultrasonic sensor, an optical sensor (for example, camera), a microphone, a battery gauge, an environment sensor (for example, a barometer, a hygrometer, a thermometer, a radioactivity detection sensor, a thermal sensor, and a gas sensor, etc.), and a chemical sensor (for example, an electronic nose, a healthcare sensor, a biometric sensor, and the like). On the other hand, the mobile terminal disclosed in the present disclosure may combine various kinds of information sensed by at least two of the above-described sensors, and may use the combined information.

The power-supply unit 140c may receive external power or internal power under control of the control unit 120, such that the power-supply unit 140a may supply the received power to the constituent components included in the AR device 100a. The power-supply unit 140c may include, for example, a battery. The battery may be implemented as an embedded battery or a replaceable battery.

At least some of the components may operate in cooperation with each other to implement an operation, control, or control method of the AR device 100a according to various embodiments described below. In addition, the operation, control, or control method of the mobile terminal may be implemented in the AR device 100a by driving at least one application program stored in the memory unit 130.

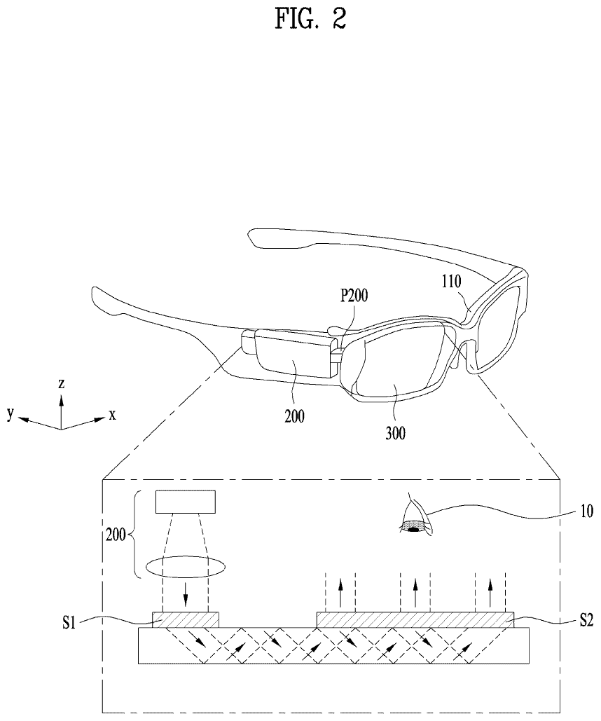

FIG. 2 is a diagram illustrating an AR device implemented as AR glasses according to an embodiment of the present disclosure.

Referring to FIG. 2, the AR glasses may include a frame, a control unit 200, and an optical display unit 300. Here, the control unit 200 may correspond to the control unit 120 described above in FIG. 1, and the optical display unit 300 may correspond to one module of the I/O unit 140a described above in FIG. 1.

Although the frame may be formed in a shape of glasses worn on the face of the user 10 as shown in FIG. 2, the scope or spirit of the present disclosure is not limited thereto, and it should be noted that the frame may also be formed in a shape of goggles worn in close contact with the face of the user 10.

The frame may include a front frame 110 and first and second side frames.

The front frame 110 may include at least one opening, and may extend in a first horizontal direction (i.e., an X-axis direction). The first and second side frames may extend in the second horizontal direction (i.e., a Y-axis direction) perpendicular to the front frame 110, and may extend in parallel to each other.

The control unit 200 may generate an image to be viewed by the user 10 or may generate the resultant image formed by successive images. The control unit 200 may include an image source configured to create and generate images, a plurality of lenses configured to diffuse and converge light generated from the image source, and the like. The images generated by the control unit 200 may be transferred to the optical display unit 300 through a guide lens P200 disposed between the control unit 200 and the optical display unit 300.

The control unit 200 may be fixed to any one of the first and second side frames. For example, the control unit 200 may be fixed to the inside or outside of any one of the side frames, or may be embedded in and integrated with any one of the side frames.

The optical display unit 300 may be formed of a translucent material, so that the optical display unit 300 can display images created by the control unit 200 for recognition by the user 10 and can allow the user to view the external environment through the opening.

The optical display unit 300 may be inserted into and fixed to the opening contained in the front frame 110, or may be located at the rear surface (interposed between the opening and the user 10) of the opening so that the optical display unit 300 may be fixed to the front frame 110. For example, the optical display unit 300 may be located at the rear surface of the opening, and may be fixed to the front frame 110 as an example.

Referring to the AR device shown in FIG. 42, when images are incident upon an incident region S1 of the optical display unit 300 by the control unit 200, image light may be transmitted to an emission region S2 of the optical display unit 300 through the optical display unit 300, and images created by the control unit 200 can be displayed for recognition by the user 10.

Accordingly, the user 10 may view the external environment through the opening of the frame 100, and at the same time may view the images created by the control unit 200.

FIGS. 3A and 3B are conceptual diagrams illustrating the AR device according to an embodiment of the present disclosure.

Referring to FIG. 3A, the AR device according to the embodiment of the present disclosure may have various structures. For example, the AR device may include a neckband 301 including a microphone and a speaker, and glasses 302 including a display unit and a processing unit. At this time, the internal input of the AR device may be performed through a button on the glasses 302, and the external input of the AR device may be performed through a controller 303 in the form of a watch or fidget spinner. In addition, although not shown in the drawing, the AR device may have a battery separation structure to internalize the LTE modem and spatial recognition technology. In this case, the AR device can implement lighter glasses 302 by separating the battery.

However, in the case of such an AR device, since the processing unit is included in the glasses 302, it is still not possible to reduce the weight of the glasses 302.

In order to address the above-described issues, referring to FIG. 3B, the AR device may use the processing unit of the mobile terminal 100b, and the AR device can be implemented with glasses 302 that simply function as a display unit. At this time, the internal input of the AR device can be performed through the button of the glasses 302, and the external input of the AR device can be performed through a ring-shaped controller 303.

AR devices must select necessary input devices and technologies in consideration of type, speed, quantity, and accuracy depending on the service. Specifically, when the service provided by the AR device is a game, input for interaction requires direction keys, mute on/off selection keys, and screen scroll keys, and joysticks and smartphones can be used as the (input) device. In other words, game keys that fit the human body must be designed, and keys must be easily entered using a smartphone. Therefore, high speed and a small amount of data input are required in limited types.

On the other hand, if the service provided by the AR device is a video playback service, such as YouTube, or a movie, the interaction input requires direction keys, playback (playback, movement) keys, mute on/off selection keys, and screen scroll keys. Such devices can be designed to use glasses, external controllers, and smart watches. In other words, the user of the AR device must be able to easily input desired data to the device using direction keys for content selection, play, stop, and volume adjustment keys. Therefore, limited types of devices are required, a normal speed and a small amount of data input are also required for such devices.

As another example, if the service provided by the AR device is a drone, the interaction input may require directional keys for controlling the drone, special function ON/OFF keys, and screen control keys, and a dedicated controller and smartphone may be used as the device. That is, the present disclosure is characterized in that the input device includes an adjustment (or control) mode, left keys (throttle, rudder), right keys (pitch, aileron), and requires limited types, a normal speed, and a normal amount of input.

Finally, when the services provided by the AR device are Metaverse, Office, and SNS, input of interaction requires various letters (e.g., English, Korean, Chinese characters, Arabic, etc.) for each language, and virtual keyboards and external keyboards can be used as devices. In addition, the virtual keyboard of the light emitting type has poor input accuracy and operates at a low speed, and an external keyboard is invisible on the screen and can be seen by the user's eyes, so that the user must input desired data or commands to the virtual keyboard using the sense of his or her fingers. In other words, a variety of language types must be provided to the virtual keyboard, and a fast speed, a large amount of data input, and accurate data input are required for the virtual keyboard.

Accordingly, in the present disclosure, a text input method when the service provided by the AR device is the metaverse will be described in detail with reference to the attached drawings.

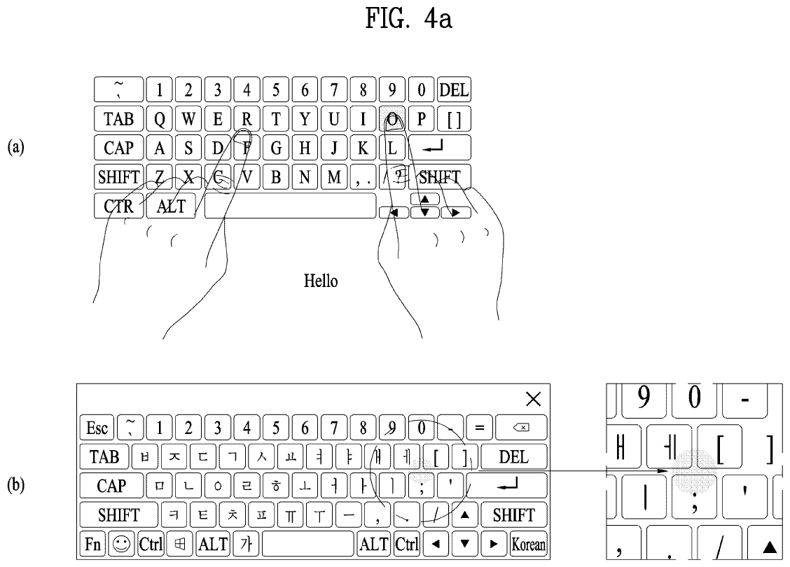

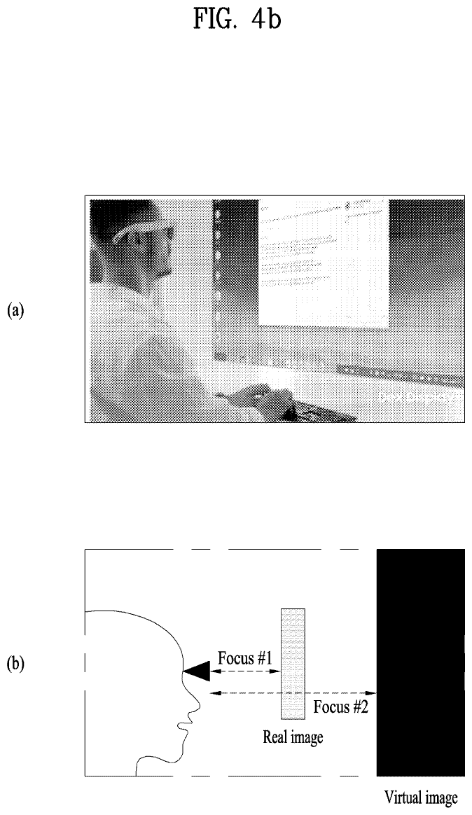

FIGS. 4A and 4B are diagrams illustrating problems of a text input method of a conventional AR device.

Referring to (a) of FIG. 4A, a situation in which the user inputs a text or command to the virtual keyboard provided by the AR device using his or her fingers will be described in detail. In such a mixed reality environment input, simple controls are available, but sophisticated input such as keyboard character input is impossible. In other words, users who do not completely memorize the keyboard layout have difficulty in using the virtual keyboard.

When typing on the virtual keyboard provided by the AR device with the user's real fingers, a convergence-accommodation mismatch problem occurs. In other words, the focus of the user's eyes in the actual 3D space is not mismatched with the real image and the virtual image. At this time, for accurate input to the virtual keyboard, the AR device must accurately determine how many times the user has moved his or her eyes and process whether what the user sees has been correctly recognized.

As shown in (b) of FIG. 4A, a problem may also occur when data is input to a virtual keyboard provided by the AR device through the user's eye tracking. There is a difficulty in separating each syllable, and since the inter-pupil distance (IPD) is different for each user, and boundaries between buttons of the keyboard become ambiguous, and thus there is a high possibility of incorrect input due to the user's gaze processing.

Referring to (a) of FIG. 4B, most commercially available AR devices implemented as AR glasses usually have a tint with a transmittance of 20% or less to reduce current consumption of the design or the optical system, making it difficult for the user to see a real image on the virtual content. For example, in the case of the NTT DCM glasses prototype developed by the iLab company in 2020, it can be seen that the NTT DCM glasses are designed with a transmittance of 0.4% to 16%.

In other words, the AR device implemented as AR glasses with a single focus is usually focused based on a long distance (more than 2.5 m), so the user may experience inconvenience or difficulty in keyboard typing (or inputting) because he or she has to perform typing while alternately looking at distant virtual content and a real keyboard that is about 40 cm long. Referring to (b) of FIG. 4B, there is a difference in focus between the real keyboard and the virtual keyboard, which may cause the user to feel dizzy.

Accordingly, the present disclosure provides a method for enabling the user to accurately input letters or text messages using the AR device, and a detailed description thereof will be given below with reference to the attached drawings.

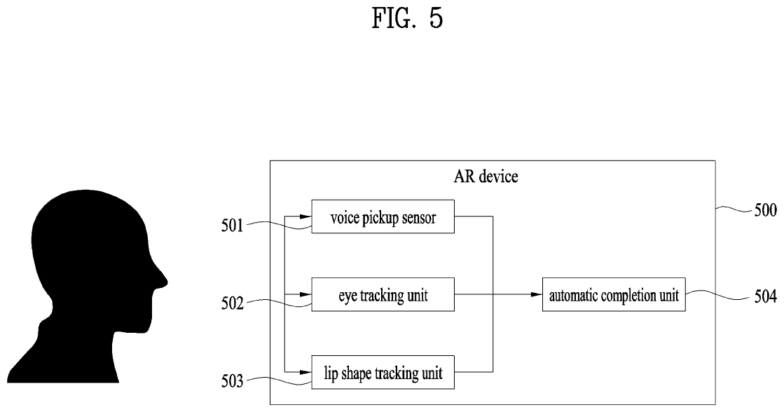

FIG. 5 is a diagram illustrating constituent modules of the AR device 500 according to an embodiment of the present disclosure.

Referring to FIG. 5, the AR device 1000 may include a voice pickup sensor 501, an eye tracking unit 502, a lip shape tracking unit 503, and an automatic completion unit 504. The constituent components shown in FIG. 1 are not always required to implement the AR device 500, such that it should be noted that the AR device 500 according to the present disclosure may include more or fewer components than the elements listed above. Additionally, not all of the above-described constituent components are shown in detail in the attached drawings, and only some important components may be shown in the attached drawings. However, although not all shown, those skilled in the art may understand that at least the constituent components of FIG. 5 may be included in the AR device 500 to implement a function as a hearing assistance device.

Referring to FIG. 5, the AR device 500 may include all the basic components of the AR device 100a described above in FIG. 1, as well as a voice pickup sensor 501, an eye tracking unit 502, and a lip shape tracking unit 503, and an automatic completion unit 504.

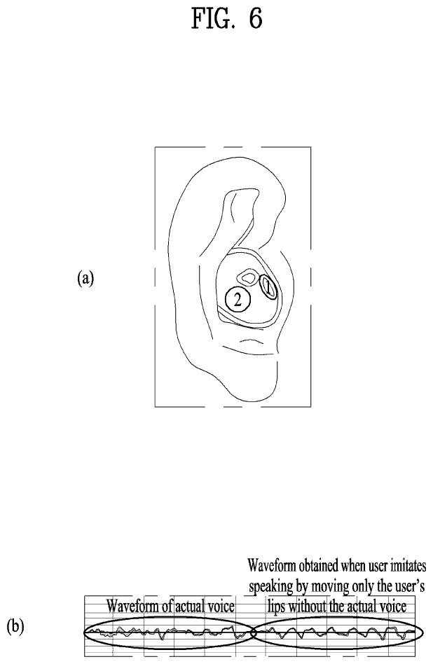

The voice pickup sensor 501 may sense the occurrence of a text input. At this time, the voice pickup sensor 501 may detect the occurrence of one letter (or character) input based on the movement of the user's skull-jaw joint. In other words, the voice pickup sensor 501 may use a bone conductor sensor to recognize the user's intention that he or she is speaking a single letter without voice generation. The voice pickup sensor 501 will be described in detail with reference to FIG. 6. The eye tracking unit 502 may detect the user's eye movement through a camera. The user can sequentially gaze at letters desired to be input on the virtual keyboard.

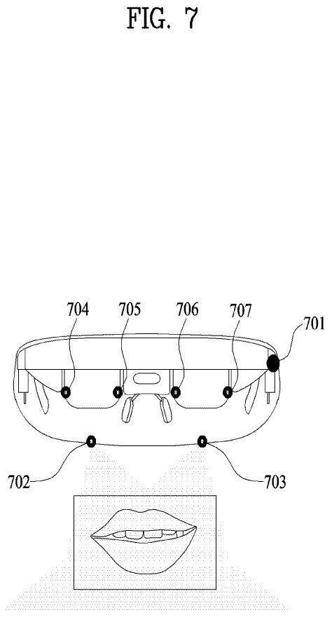

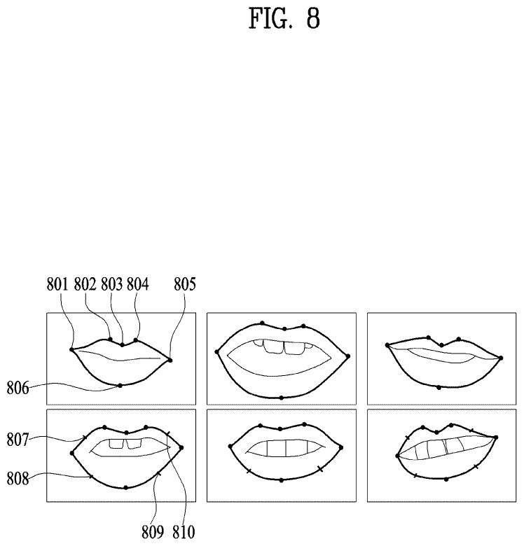

The lip shape tracking unit 503 may infer letters (or characters). The lip shape tracking unit 503 may recognize the range of letters (or characters). At this time, the lip shape tracking unit 503 may infer letters (or characters) through the IR camera and the IR illuminator. Here, the IR camera and the IR illuminator may be arranged to photograph (or capture) the user's lips at a preset angle. This will be explained in detail with reference to FIGS. 7 and 8.

Additionally, the lip shape tracking unit 503 may infer letters (or characters) based on the time when the eye tracking unit 502 detects the user's pupils. At this time, the shape of the lips needs to be maintained until one letter is completed. Additionally, the lip shape tracking unit 503 can infer letters (or characters) using artificial intelligence (AI). That is, when the AR device 500 is connected to the external server, the AR device can receive letters (or characters) that can be inferred from the artificial intelligence (AI) server, and can infer letters by combining the received letters with other letters recognized by the lip shape tracking unit 503. Additionally, through the above-described function, the AR device 500 can provide the mouth shape and expression of the user's avatar in the metaverse virtual environment.

The automatic completion unit 504 may complete the word based on the inferred letters. Additionally, the automatic completion unit 504 may automatically complete not only words but also sentences. The automatic completion unit 504 can recommend modified or completed word or sentence candidates when a few letters or words are input to the AR device. At this time, the automatic completion unit 504 can utilize the auto-complete functions of the OS and applications installed in the AR device 500.

Additionally, according to one embodiment of the present disclosure, the AR device 500 may determine the eye tracking unit 502 to be a main input means, may determine the lip shape tracking unit 503 to be an auxiliary input means, and may determine the automatic completion unit 504 to be an additional input means. This means that, through the shape of the user's lips, it is possible for the AR device to detect the movement of consonants and vowels and to recognize whether the shape of lips remains in a consonant state, but it is impossible for the AR device capable of identifying the shape of the user's lips to completely recognize letters or words due to homonyms. To compensate for this issue, the AR device 500 can set the eye tracking unit 502 as a main input means.

Additionally, although not shown in the drawings, the AR device 500 may further include a display unit. The display unit has been described with reference to FIG. 1.

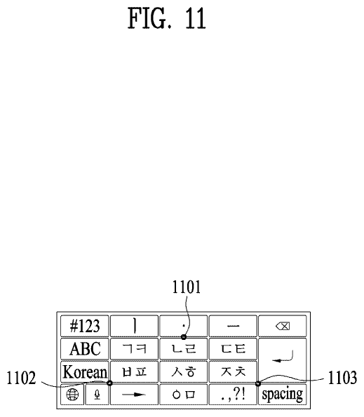

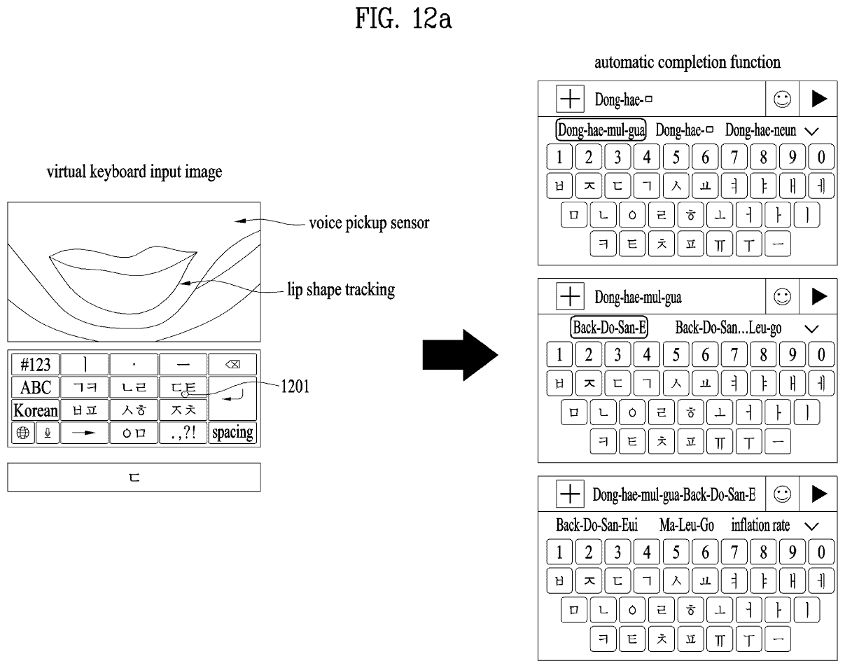

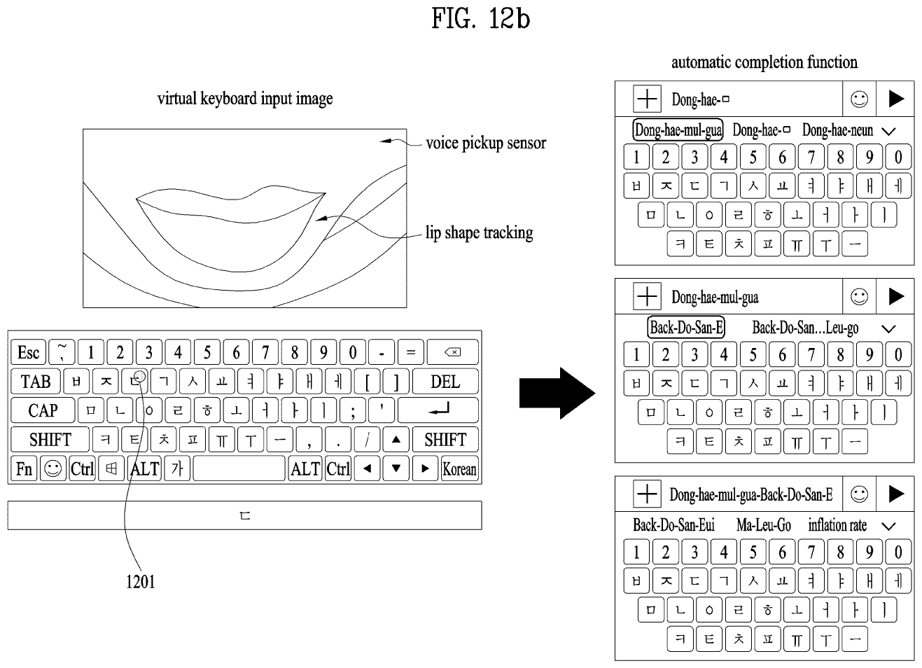

In one embodiment of the present disclosure, the display unit may output a text input device (IME), and may output a pointer on the text input device based on the user's eye movement detected by the eye tracking unit 502. In addition, the display unit can output a completed word or sentence through the automatic completion unit 504. This will be described in detail with reference to FIGS. 11, 12A, and 12B.

Also, although not shown in the drawings, the AR device 500 may further include an input unit. The input unit has been described above with reference to FIG. 1. According to an embodiment of the present disclosure, the voice pickup sensor 501 may start confirmation of text (or letters) input based on a control signal received from the input unit. For example, when a control signal is received from the input unit through activation of a physical button or a virtual button, the voice pickup sensor 501 may start confirmation of text input.

Also, although not shown in the drawings, the AR device 500 may further include a memory unit. The memory unit has been described above with reference to FIG. 1. According to an embodiment of the present disclosure, the lip shape tracking unit 503 may infer letter(s) or text message(s) based on a database included in the memory unit.

As a result, it is possible for the user to conveniently input sophisticated letters (or text messages) to the AR device without using the external keyboard or controller.

That is, outdoors or in an environment requiring quiet, the AR device may precisely input letters (or characters) using glasses multi-sensing.

When the AR device is worn by the user, the user may have difficulty in using the actual external keyboard. When the virtual content is displayed in front of the user's eyes, the actual external keyboard is almost invisible. Additionally, when the letter input means is a virtual keyboard, only the eye tracking function is used, so that the accuracy of letter recognition in the AR device is significantly deteriorated. To compensate for this issue, the AR device according to the present disclosure can provide multi-sensing technology capable of listening, watching, reading, writing, and correcting (or modifying) necessary information.

According to a combination of multi-sensing technologies for input data, the accuracy of data input can significantly increase and a time consumed for such data input can be greatly reduced as compared to text input technology capable of using only eye tracking. As an additional function, facial expressions for avatars can be created so that the resultant avatars can be used in the metaverse. In particular, when the users inputs letters (or text) to the AR device in various public places (e.g., buses or subways) where the user has to pay attention to other people's gaze, or when the user writes e-mails or documents using a large screen or second display in a virtual office environment, technology of the present disclosure can be applied to the metaverse market (in which facial expressions based on the shape of the user's lips can be applied to avatars and social relationships can be formed in virtual spaces), can be easily used by the hearing impaired and physically disabled people who cannot use voice or hand input functions, and can also be applied to laptops or smart devices in the future.

FIG. 6 is a diagram illustrating the voice pickup sensor according to an embodiment of the present disclosure.

Referring to FIG. 6(a), when the voice pickup sensor is inserted into the user's ear, the voice pickup sensor can detect the movement of the user's skull-jaw joint and check letter (or character) input and the spacing between letters (or characters).

Referring to FIG. 6(b), a waveform when “Ga( [symbol] ), Na( [symbol] ), Da( [symbol] ), Ra( [symbol] ), Ma( [symbol] ), Ba( [symbol] ), and Sa( [symbol] )” are pronounced vocally by the user and another waveform when “Ga( [symbol] ), Na( [symbol] ), Da( [symbol] ), Ra( [symbol] ), Ma( [symbol] ), Ba( [symbol] ), and Sa( [symbol] )” are pronounced with only the mouth shape are shown. In other words, it can be seen that the waveform detected by the voice pickup sensor through the movement of the user's skull-jaw joint is almost similar to the actual voice waveform.

In other words, even if the voice pickup sensor does not detect the actual voice, the voice pickup sensor can detect the presence or absence of letter input or the spacing between letters by sensing the movement of the user's skull-jaw point. As a result, the occurrence of letter input and the spacing between letters can be detected 50 to 80% more accurately as compared to an example case in which the user can use only a general microphone in a noisy environment.

FIG. 7 is a diagram illustrating an example of sensors arranged in the AR device according to an embodiment of the present disclosure.

Referring to FIG. 7, the voice pickup sensor 701 may be located on a side surface of the AR device when the user wears the AR device to check the sound of bone conduction.

Additionally, the cameras (702, 703) of the lip shape tracking unit may be arranged to photograph the user's lips at a preset angle (for example, 30 degrees). In particular, the cameras (702, 703) of the lip shape tracking unit need to determine only the shape of the user's lips as will be described later in FIG. 8. Thus, assuming that the angle between the camera and the user's lips is correct, a low-resolution camera can also be used without any problems. In addition, the positions of the IR camera and the IR illuminator can be selectively arranged.

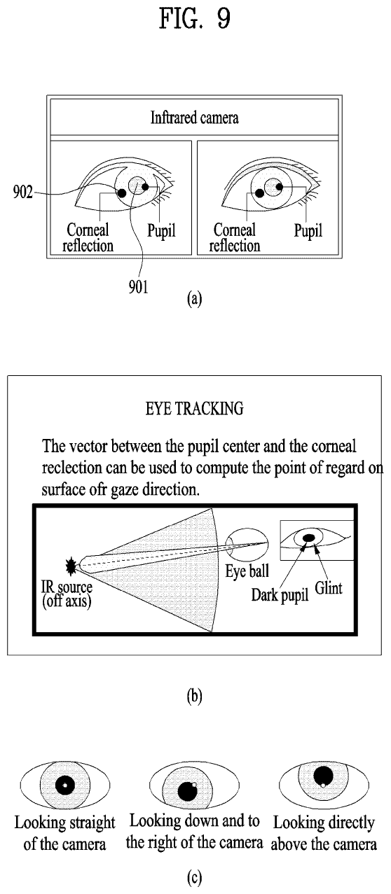

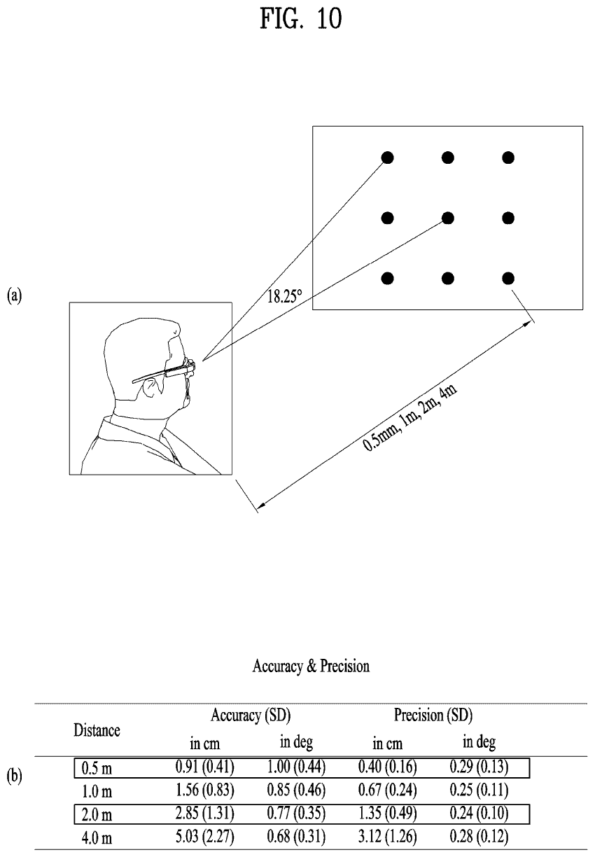

Lastly, the cameras (704, 705, 706, 707) of the eye tracking unit may be arranged in the left and right directions of both eyes of the user to recognize the movement of the user's eyes. An embodiment in which each camera of the eye tracking unit detects the movement of the user's eyes will be described in detail with reference to FIGS. 9 and 10.

FIG. 8 is a diagram illustrating a tracking result of the lip tracking unit according to an embodiment of the present disclosure.

Referring to FIG. 8, the AR device can obtain the results of tracking the shape of the user's lips by the lip tracking unit. That is, the rough shape of a person's lips can be identified through the IR camera and the IR illuminator. At this time, the lip tracking unit does not need to use a high-quality camera, but simply generates the outermost boundary points (801, 802, 803, 804, 805, 806) to identify the shape of lips, generates intermediate boundary points (807, 807, 808, 809, 810), and creates a line connecting the same. As a result, the lip tracking unit can identify the lip shape for each letter (or character).

FIG. 9 is a diagram illustrating the operations of the eye tracking unit according to an embodiment of the present disclosure.

Referring to (a) of FIG. 9, the infrared (IR) camera of the eye tracking unit can distinguish and identify the pupil 901 and the corneal reflection 902 of the user's pupils.

Referring to (b) of FIG. 9, the eye tracking unit may output infrared (IR) sources to the eye (eyeball), and may recognize the direction of user's gaze through a vector between the center of the pupil 901 and the corneal reflection 902.

Referring to (c) of FIG. 9, through the above-described method, the eye tracking unit may determine whether the user's eyes are looking straight ahead, are looking at the bottom right of the camera, or are looking above the camera.

FIG. 10 is a diagram illustrating the accuracy of the eye tracking unit according to an embodiment of the present disclosure.

Referring to (a) of FIG. 10, in order to confirm the eye tracking results when the user gazes at a point on a screen after wearing the AR device, an experiment for an example case in which the distance between the on-screen point and the user becomes longer is illustrated.

Referring to (b) of FIG. 10, it can be seen that a standard deviation for a single point at a position where the distance between the on-screen point and the user is 0.5 m is shown as 0.91 cm or less, and a standard deviation for a single point at a position where the distance between the on-screen point and the user is 2 m is shown as 2.85 cm.

In other words, assuming that the virtual keyboard is placed 50 cm in front of the user, it is expected that more accurate text (or letters) input will be possible because the standard deviation for one point is shown as 0.91 cm or less.

FIG. 11 is a diagram illustrating a text input environment of the AR device according to an embodiment of the present disclosure.

Referring to FIG. 11, the total screen size of the virtual content that can be viewed by the user wearing the AR device is 14.3 inches (e.g., width 31 cm, height 18 cm), and the size of the virtual keyboard located 50 cm in front of the user is 11.7 inches (e.g., width 28 cm, height 10 cm). At this time, it can be assumed that the field of view (FOV) of the above-described camera is 40 degrees and the resolution is FHD.

In this case, the AR device may first perform a correction operation on three points (1101, 1102, 1103) to determine whether recognition of the user's eye movement is accurate. Afterwards, when the correction operation is completed, the AR device can receive text (or letter) input through the user's eye tracking.

FIGS. 12A and 12B are diagrams showing text input results of the AR device according to an embodiment of the present disclosure. FIG. 12A shows an example in which a Cheonjiin keyboard is used as a virtual keyboard, and FIG. 12B shows an example in which a QWERTY keyboard is used as a virtual keyboard.

Referring to FIG. 12A, the display unit of the AR device can output the Cheonjiin keyboard. Thereafter, when text input (or letter input) begins, the voice pickup sensor may recognize one letter unit based on the movement of the user's skull-jaw joint. At the same time, the lip shape tracking unit can infer letter(s) by analyzing the shape of the user's appearance recognized through the camera. Additionally, at the same time, the eye tracking unit can output a pointer 1201, which is recognized based on the movement of the user's eyes detected through the camera, on the Cheonjiin keyboard. Referring to FIG. 12A, if the user pronounces “⊏” and gazes at “⊏” on the Cheonjiin keyboard, the AR device can output a pointer 1201 at the position of “⊏” on the Cheonjiin keyboard. In one embodiment of the present disclosure, the screen actually viewed by the user through the display unit may correspond to the virtual Cheonjiin keyboard and the pointer 1201.

Referring to the example of FIG. 12A, when the user pronounces “Donghae ▭ ( [symbol] )” through the shape of his or her mouth, the AR device can detect the “Donghae ▭” using the voice pickup sensor, the lip shape tracking unit, and the eye tracking unit. Afterwards, the AR device can output “Dong-hae-mul-gua ( [symbol] )” through the automatic completion unit. When the eye tracking unit determines that the movement of the user's eyes indicates that the user gaze at the next automatic completion sentence “Back-Do-San-E ( [symbol] )”, the AR device can output the completed sentence “Dong-hae-mul-gua-Back-Do-San-E ( [symbol] [symbol] )”.

Likewise, referring to FIG. 12B, the display unit of the AR device can output the QWERTY keyboard. Thereafter, when text input begins, the voice pickup sensor may recognize one letter unit based on the movement of the user's skull-jaw joint. At the same time, the lip shape tracking unit can infer the letter(s) or text by analyzing the shape of the user's appearance recognized through the camera. Additionally, at the same time, the eye tracking unit can output the pointer 1201, which is recognized based on eye movement detected through the camera, on the QWERTY keyboard. Referring to the example of FIG. 12B, when the user pronounces “⊏” and gazes at “⊏” on the QWERTY keyboard, the AR device can output the pointer 1201 at the position of “⊏” on the QWERTY keyboard. In one embodiment of the present disclosure, the screen actually viewed by the user through the display unit may correspond to the virtual QWERTY keyboard and the pointer 1201.

Additionally, the embodiment in which the AR device completes words or sentences through the automatic completion unit is the same as the content described above in FIG. 12A.

In other words, according to the existing AR device, when using the virtual keyboard, in order to distinguish between “└” and “ [symbol] ”, the user had to wait for a certain period of time (causing a time delay) or the user should conduct additional selection. In contrast, the AR device according to the present disclosure may perform eye tracking and lip shape tracking at the same time, so that the AR device can quickly distinguish between letters (or characters).

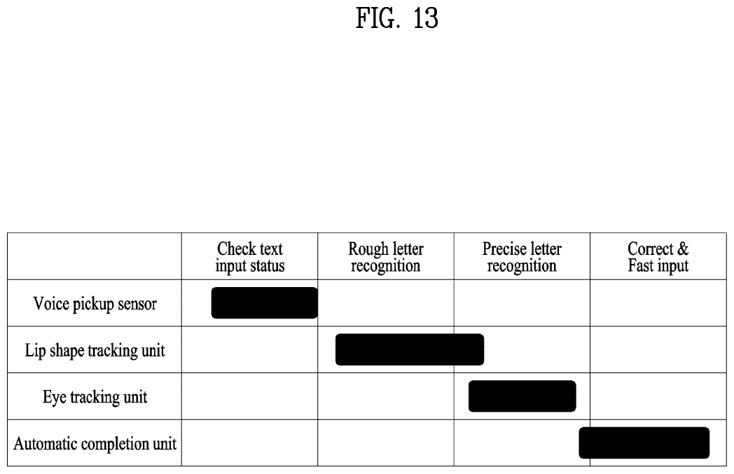

FIG. 13 is a diagram illustrating a table predicting a recognition rate for text input in the AR device according to an embodiment of the present disclosure.

Referring to FIG. 13, the vertical contents of the table show the configuration modules of the AR device, and the horizontal contents of the table show the functions to be performed.

More specifically, the voice pickup sensor can first check the text input situation. That is, the intention of the user who desires to input text (or letters) can be determined through the voice pickup sensor. In other words, when occurrence of the user's skull-jaw joint movement is detected by the voice pickup sensor, the AR device can start text (letters) recognition using the eye tracking unit and the lip shape tracking unit. The voice pickup sensor can use bone conduction, and can check whether text input is conducted in units of one letter (or one character). As a result, the level at which text input can be confirmed can be predicted to be 95%. Additionally, when the AR device is located in an independent space that does not require quiet or silence, the AR device can recognize input data through voice recognition instead of bone conduction.

The lip shape tracking unit can perform approximate letter (or character) recognition. However, the lip shape tracking unit is vulnerable to homonyms, which are different sounds with the same mouth shape. Therefore, the AR device has to recognize text messages (or letters) while performing the eye tracking. When text recognition is started through the lip shape tracking unit, the level at which text input can be confirmed can be predicted to be 100%.

The eye tracking unit enables precise text (or letter) recognition. In other words, the AR device may perform more accurate text recognition by combining rough text (letters) recognized by the lip shape tracking unit with content recognized by the eye tracking unit. In particular, since the accuracy of the eye tracking unit is improved at the optimal position, an example point is provided as shown in FIG. 11 so that a correction (or calibration) operation can be conducted. The recognition rate of letters (characters) recognized through the eye tracking unit can be predicted to be 95%.

The automatic completion unit can provide correction and automatic completion functions for letters (characters) recognized through the eye tracking unit and the lip shape tracking unit. The recognition rate of letters (or characters) increases to 99% and the input time of such letters can be reduced by 30% after the correction and automatic completion functions are provided through the automatic completion unit.

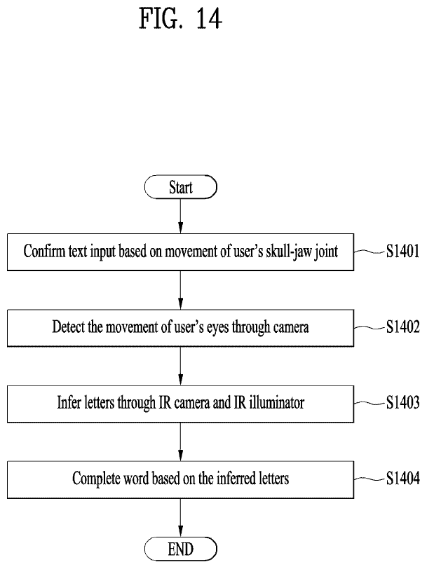

FIG. 14 is a flowchart illustrating a method of controlling the AR device according to an embodiment of the present disclosure.

Referring to FIG. 14, occurrence of text input (or letter input) may be confirmed based on the movement of the user's skull-jaw joint (S1401). At this time, the text input can be confirmed based on the movement of the user's skull-jaw joint through the voice pickup sensor. At this time, occurrence of a text input can be confirmed based on only one letter (or one character). Here, the voice pickup sensor can be activated based on the control signal received through the input unit.

In step S1402, the movement of the user's pupil can be detected through the camera.

In step S1403, text or letters can be inferred through the IR camera and the IR illuminator. At this time, text or letters can be inferred based on the time of sensing the movement of the pupil. Further, the IR camera and the IR illuminator may be arranged to capture the user's lips at a preset angle (e.g., between 30 degrees and 40 degrees). In addition, not only letter(s) recognized by the IR camera and the IR illuminator, but also other letter(s) can be interfered by applying a database and artificial intelligence (AI) technology to the recognized letter(s).

In step S1404, the word can be completed based on the inferred letters. Afterwards, the completed word can be output through the display unit.

The embodiment of the present disclosure can address or obviate user inconvenience in text input, which is the biggest problem of AR devices. In particular, since the AR device according to the present disclosure can implement sophisticated text input through multi-sensing, the importance of technology of the AR device according to the present disclosure will greatly increase in the metaverse AR glasses environment.

Various embodiments may be implemented using a machine-readable medium having instructions stored thereon for execution by a processor to perform various methods presented herein. Examples of possible machine-readable mediums include HDD (Hard Disk Drive), SSD (Solid State Disk), SDD (Silicon Disk Drive), ROM, RAM, CD-ROM, a magnetic tape, a floppy disk, an optical data storage device, the other types of storage mediums presented herein, and combinations thereof. If desired, the machine-readable medium may be realized in the form of a carrier wave (for example, a transmission over the Internet). Further, the computer may include the control unit 180 of the image editing device. The foregoing embodiments are merely exemplary and are not to be considered as limiting the present disclosure. The present teachings can be readily applied to other types of methods and apparatuses. This description is intended to be illustrative, and not to limit the scope of the claims. Many alternatives, modifications, and variations will be apparent to those skilled in the art. The features, structures, methods, and other characteristics of the exemplary embodiments described herein may be combined in various ways to obtain additional and/or alternative exemplary embodiments.

### INDUSTRIAL APPLICABILITY

Embodiments of the present disclosure have industrial applicability because they can be repeatedly implemented in AR devices and AR device control methods.

1-11. (canceled)

12. An augmented reality (AR) device comprising:
a voice pickup sensor configured to confirm an input of at least one letter;
an eye tracker comprising at least one camera, wherein the eye tracker is configured to detect eye movement of a user through the at least one camera;
a lip shape tracker configured to infer the at least one letter; and
a processor configured to complete a word based on the inferred at least one letter.

13. The AR device according to claim 12, wherein:
the voice pickup sensor is further configured to confirm the input of the at least one letter based on bone conduction caused by movement of a skull-jaw joint of the user.

14. The AR device according to claim 13, wherein:
the lip shape tracker comprises an infrared (IR) camera and an IR illuminator; and
the lip shape tracker is further configured to infer the at least one letter through the IR camera and the IR illuminator.

15. The AR device according to claim 14, wherein:
the lip shape tracker is further configured to infer the at least one letter based on a time taken for the eye tracker to sense the eye movement of the user.

16. The AR device according to claim 15, wherein:
the IR camera and the IR illuminator are positioned to photograph lips of the user at a preset angle.

17. The AR device according to claim 16, further comprising:
a display,
wherein
the display is configured to output an image of a letter input device and further output a pointer on the image of the letter input device based on the detected eye movement of the user.

18. The AR device according to claim 17, wherein:
the display is further configured to output the completed word obtained through the processor.

19. The AR device according to claim 12, further comprising:
an input device,
wherein
the voice pickup sensor is further configured to start confirmation of the input of the at least one letter based on a control signal received through the input device.

20. The AR device according to claim 12, further comprising:
a memory device,
wherein
the lip shape tracker is further configured to infer the at least one letter based on a database stored in the memory device.

21. The AR device according to claim 12, wherein:
the lip shape tracker is further configured to infer the at least one letter using artificial intelligence (AI).

22. A method for controlling an augmented reality (AR) device, the method comprising:
confirming an input of at least one letter based on bone conduction caused by movement of a skull-jaw joint of a user;
detecting, via a camera, eye movement of the user;
inferring, via an infrared (IR) camera and an IR illuminator, the at least one letter; and
completing a word based on the inferred at least one letter.
